(19) United States
(12) Patent Application Publication
(10) Pub. No.: US 2026/0099190 A1
(43) Pub. Date: Apr. 9, 2026

(54) INFORMATION ACQUISITION APPARATUS, INFORMATION ACQUISITION SYSTEM, AND INFORMATION PROCESSING SYSTEM

(71) Applicant: NEC Corporation, Minato-ku, Tokyo (JP)

(72) Inventor: Yoshinori KODA, Tokyo (JP)

(73) Assignee: NEC Corporation, Minato-ku, Tokyo (JP)

(21) Appl. No.: 19/111,870

(22) PCT Filed: Sep. 30, 2022
(86) PCT No.: PCT/JP2022/036730

§ 371 Date: Mar. 14, 2025

(51) Int. Cl. G06F 3/01; G06F 1/16

(52) U.S. Cl. CPC G06F 3/011; G06F 1/1633

(57) ABSTRACT

An information acquisition apparatus includes: a connecting unit to be connected to an information acquisition unit that acquires biometric information; a storage unit that stores therein the biometric information acquired by the information acquisition unit; and a transmission unit that transmits the biometric information stored in the storage unit, to another apparatus.

This application is a National Stage Entry of PCT/JP2022/036730 filed on Sep. 30, 2022, the contents of all of which are incorporated herein by reference, in their entirety.

### TECHNICAL FIELD

This disclosure relates to technical fields of an information acquisition apparatus, an information acquisition system, an information processing system, an information acquisition method, and a recording medium.

### BACKGROUND ART

Patent Literature 1 describes a technique/technology in which an electronic thermometer that has finished measurement in advance, is inserted into a biometric information measuring device housing part engaged with an upper case at a predetermined position, and a hall element serving as a magnetic sensor detects magnetic force of a magnet reed switch built in the thermometer, and automatically starts reading of body temperature data based on a flashing pattern of a part of a display unit.

Patent Literature 2 describes the following technique/technology. A sensor, a storage circuit, a collation/verification circuit, and a communication circuit are integrally formed in an authentication token. Fingerprints of a user are detected by the sensor 11. A detected result is outputted as sensing data. The collation/verification circuit collates/verifies the sensing data from the sensor with registered fingerprint data stored in the storage circuit, and outputs a collated result indicating a user authentication result as authenticated data, and the authenticated data are transmitted from the communication circuit to a use device as communication data. The use device executes prescribed processing based on the authenticated data received as the communication data from the authentication token.

Patent Literature 3 describes the following technique/technology. In a digital camera, a light source unit for fingerprint authentication is detachably attached to an end portion of a lens barrel via a connector. In the light source unit, four light emitting elements are arranged at equal intervals at positions shifted by 90 degrees from each other. A light emitting element driver allows the four light emitting elements to emit light one by one in different timing. A CCD driver controls drive of a CCD such that fingerprints are photographed in driving timing of the light emitting element at each time. The light emitting element driver adjusts the quantity of light of each light emitting element, based on a color temperature of an object detected by an AE/AWB detection circuit.

Patent Literature 4 describes a technique/technology including: a mounting part on which a finger is mounted; an image acquisition part that is placed below the mounting part and authenticates a fingerprint of the finger mounted on the mounting part; a finger sensor that detects whether or not the finger is mounted on the mounting part; and an ultraviolet ray irradiation lamp that is placed above the mounting part and irradiates the mounting part with ultraviolet rays. The ultraviolet ray irradiation lamp irradiates the mounting part with the ultraviolet rays at a time, when the finger sensor does not detect the finger. It is possible to prevent viral or bacterial infection and to perform fingerprint authentication, quickly and accurately.

### CITATION LIST

### Patent Literature

Patent Literature 1: JPH09-266890A
Patent Literature 2: JP2002-278640A
Patent Literature 3: JP2007-142558A
Patent Literature 4: JP2011-232990A

### SUMMARY

It is an example object of this disclosure to provide an information acquisition apparatus, an information acquisition system, an information processing system, an information acquisition method, and a recording medium that aim to improve the techniques/technologies disclosed in Citation List.

### Solution to Problem

An information acquisition apparatus according to an example aspect includes: a connecting unit to be connected to an information acquisition unit that acquires biometric information; a storage unit that stores therein the biometric information acquired by the information acquisition unit; and a transmission unit that transmits the biometric information stored in the storage unit, to another apparatus.

An information acquisition system according to an example aspect includes: an information acquisition apparatus including: an information acquisition unit that acquires biometric information; a connecting unit to be connected to the information acquisition unit; a storage unit that stores therein the biometric information acquired by the information acquisition unit; and a transmission unit that transmits the biometric information stored in the storage unit, to another apparatus, wherein the information acquisition unit includes a housing or a cover member formed of a material including at least one of an ultraviolet resistant material and a boiling resistant material.

An information processing system according to an example aspect includes: an information acquisition apparatus including: an information acquisition unit that acquires biometric information; another apparatus that processes the biometric information; a connecting unit to be connected to the information acquisition unit; a storage unit that stores therein the biometric information acquired by the information acquisition unit; and a transmission unit that transmits the biometric information stored in the storage unit, to the other apparatus, wherein in response to the transmission unit transmitting the biometric information stored in the storage unit to the other apparatus, the other apparatus stores each of the received biometric information, with a same living body identification number added thereto, and the storage unit deletes the stored biometric information.

An information acquisition method according to an example aspect includes: connecting to an information acquisition unit that acquires biometric information; storing, in a storage unit, the biometric information acquired by the information acquisition unit; and transmitting the biometric information stored in the storage unit, to another apparatus.

A recording medium according to an example aspect is a recording medium on which a computer program that allows a computer to execute an information acquisition method is recorded, the information acquisition method including: connecting to an information acquisition unit that acquires biometric information; storing, in a storage unit, the biometric information acquired by the information acquisition unit; and transmitting the biometric information stored in the storage unit, to another apparatus.

### BRIEF DESCRIPTION OF DRAWINGS

FIG. 1 is a block diagram illustrating a configuration of an information acquisition apparatus in a first example embodiment.

FIG. 2A is an external view of an information acquisition system in a second example embodiment.

FIG. 2B is an external view of an information acquisition system in a second example embodiment.

FIG. 2C is an external view of an information acquisition system in a second example embodiment.

FIG. 2D is an external view of an information acquisition system in a second example embodiment.

FIG. 2E is an external view of an information acquisition system in a second example embodiment.

FIG. 3A is an external view of an attachment in the second example embodiment.

FIG. 3B is an external view of an attachment in the second example embodiment.

FIG. 4 is a block diagram illustrating a configuration of an information acquisition system in the second example embodiment.

FIG. 5 is a flowchart illustrating a flow of an information acquisition operation of the information acquisition system in the second example embodiment.

FIG. 6 is a block diagram illustrating a configuration of an information acquisition system in a third example embodiment.

FIG. 7 is a flowchart illustrating a flow of an information acquisition operation of the information acquisition system in the third example embodiment.

FIG. 8A is an external view of an information acquisition system in a fourth example embodiment.

FIG. 8B is an external view of an information acquisition system in a fourth example embodiment.

FIG. 8C is an external view of an information acquisition system in a fourth example embodiment.

FIG. 8D is an external view of an information acquisition system in a fourth example embodiment.

FIG. 8E is an external view of an information acquisition system in a fourth example embodiment.

FIG. 9 is a flowchart illustrating a flow of an information acquisition operation of the information acquisition system in the fourth example embodiment.

FIG. 10 is an external view of an information acquisition system in a fifth example embodiment.

FIG. 11 is a block diagram illustrating a configuration of an information acquisition system in a sixth example embodiment.

FIG. 12 is a block diagram illustrating a configuration of an information processing system in a seventh example embodiment.

FIG. 13 is a flowchart illustrating a flow of an information processing operation of the information processing system in the seventh example embodiment.

FIG. 14 is an external view of an information acquisition system in an eighth example embodiment.

FIG. 15 is a block diagram illustrating a configuration of the information processing system in the eighth example embodiment.

FIG. 16 is a flowchart illustrating a flow of an information processing operation of the information processing system in the eighth example embodiment.

FIG. 17A is an external view illustrating the flow of the information processing operation of the information processing system in the eighth example embodiment.

FIG. 17B is an external view illustrating the flow of the information processing operation of the information processing system in the eighth example embodiment.

FIG. 17C is an external view illustrating the flow of the information processing operation of the information processing system in the eighth example embodiment.

FIG. 18 is a flowchart illustrating the flow of the information processing operation of the information processing system in the eighth example embodiment.

FIG. 19 is a block diagram illustrating a configuration of an information processing system in a ninth example embodiment.

### DESCRIPTION OF EXAMPLE EMBODIMENTS

Hereinafter, with reference to the drawings, an information acquisition apparatus, an information acquisition system, an information processing system, an information acquisition method, and a recording medium according to example embodiments will be described.

### 1: First Example Embodiment

An information acquisition apparatus, an information acquisition system, an information processing system, an information acquisition method, and a recording medium according to a first example embodiment will be described. The following describes the information acquisition apparatus, the information acquisition system, the information processing system, the information acquisition method, and the recording medium according to the first example embodiment, by using an information acquisition apparatus D1 to which the information acquisition apparatus, the information acquisition system, the information processing system, the information acquisition method, and the recording medium according to the first example embodiment are applied.

### [1-1: Configuration of Information Acquisition Apparatus D1]

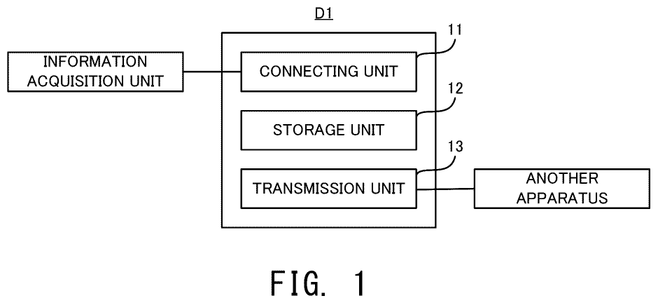

FIG. 1 is a block diagram illustrating a configuration of the information acquisition apparatus D1 in the first example embodiment. As illustrated in FIG. 1, the information acquisition apparatus D1 includes a connecting unit 11, a storage unit 12, and a transmission unit 13.

The connecting unit 11 is connected to an information acquisition unit that acquires biometric information. The storage unit 12 stores the biometric information acquired by the information acquisition unit. The transmission unit 13 transmits the biometric information stored in the storage unit 12 to another apparatus.

### [1-2: Technical Effect of Information Acquisition Apparatus D1]

Since the information acquisition apparatus D1 in the first example embodiment is configured to replace the information acquisition unit, it is possible to acquire multiple a plurality of types of biometric information by using a single apparatus and transmit it to another apparatus.

### 2: Second Example Embodiment

Next, an information acquisition apparatus, an information acquisition system, an information processing system, an information acquisition method, and a recording medium according to a second example embodiment will be described. The following describes the information acquisition apparatus, the information acquisition system, the information processing system, the information acquisition method, and the recording medium according to the second example embodiment, by using an information acquisition system S2 to which the information acquisition apparatus, the information acquisition system, the information processing system, the information acquisition method, and the recording medium according to the second example embodiment are applied.

### [2-1: External Appearance of Information Acquisition System S2]

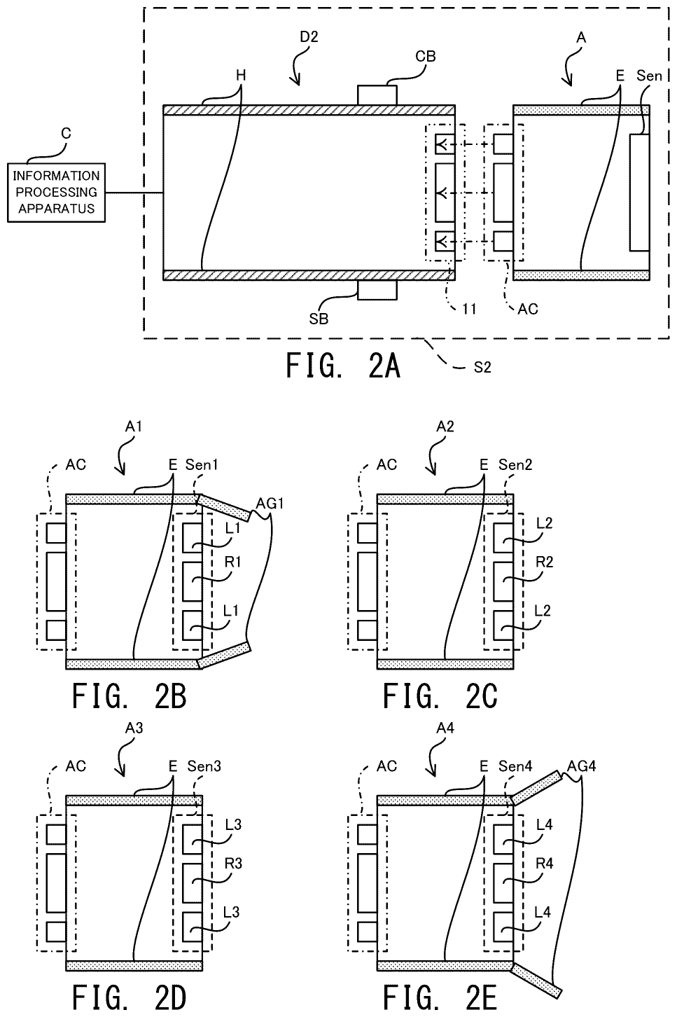

FIG. 2A is an external view of the information acquisition system S2 in the second example embodiment. As illustrated in FIG. 2A, the information acquisition system S2 in the second example embodiment may include an information acquisition apparatus D2 and an attachment A serving as the information acquisition unit that acquires the biometric information.

The information acquisition apparatus D2 includes the connecting unit 11 that is a specific example of the “connecting unit” described in Supplementary Note later, a holding part H that is a specific example of the “holding part” described in Supplementary Note later, a collection button CB that is a specific example of the “receiving unit” described in Supplementary Note later, and a send button SB. The information acquisition apparatus D2, however, may not include the send button SB.

The connecting unit 11 is a mechanism connected to the attachment A. The connecting unit 11 may be a mechanism that is physically and electrically connectable to the attachment A. The information acquisition apparatus D2 may be configured to supply electric power to the attachment A via the connecting unit 11.

The holding part H may be a housing of the information acquisition apparatus D2. The holding part H is a mechanism that allows the information acquisition apparatus D2 to be carried with one hand. The holding part H is provided with the collection button CB and the send button SB. The collection button CB receives an input of an operation instruction to the attachment A.

The information acquisition apparatus D2 is connected to an information processing apparatus C serving as another apparatus, in at least one of a wired manner and a wireless manner. The send button SB may receive an input of an instruction to transmit the biometric information to the information processing apparatus C.

The attachment A may include a connecting unit AC, an exterior part E, and a sensor unit Sen. The connecting unit AC may be a mechanism connected to the connecting unit 11. The exterior part E may be a housing or a cover member formed of a material including at least one of an ultraviolet (UV) resistant material and a boiling resistant material. Since the exterior part E covers the attachment A, it is possible to disinfect the attachment A as appropriate. It is thus possible to keep the attachment A clean, wherein the attachment A may be directly contacted by a living body. The sensor unit Sen will be described with reference to FIG. 2B to FIG. 2E.

FIG. 2B to FIG. 2E illustrate an example of the attachment A in the second example embodiment. In the second example embodiment, the information acquisition apparatus D2 may be connected to at least one of an attachment A1 to an attachment A4 illustrated in FIG. 2B to FIG. 2E. That is, the information acquisition system S2 may include the information acquisition apparatus D2 and a plurality of attachments A.

The attachment A1 illustrated in FIG. 2B may be an iris information collecting apparatus. A sensor unit Sen1 provided in the attachment A1 may be an iris capturing unit. The sensor unit Sen1 may include a light projecting unit L1 and a light receiving unit R1. The light projecting unit L1 may be a projector. The light projecting unit L1 may be, for example, a projector that emits light of a predetermined wavelength of a near infrared area or an infrared area. That is, the sensor unit Sen1 may irradiate a target part with the light of the predetermined wavelength of the near infrared area or the infrared area, and may capture an iris image of the target part irradiated with the light of the predetermined wavelength. The attachment A1 may include a guide member AGI that defines a predetermined range as a capturing range. The guide member AGI is configured to maintain a focal length at the time of collection of iris information.

The attachment A2 illustrated in FIG. 2C may be a facial information collecting apparatus. A sensor unit Sen2 provided in the attachment A2 may be a face capturing unit. The sensor unit Sen2 may include a light projecting unit L2 and a light receiving unit R2. The light projecting unit L2 may be a projector. The light projecting unit L2 may be a projector that emits light of a predetermined wavelength of a near infrared area or an infrared area, as in the light projecting unit L1.

The attachment A3 illustrated in FIG. 2D may be a fingerprint information collecting apparatus. A sensor unit Sen3 provided in the attachment A3 may be a fingerprint capturing unit. The sensor unit Sen3 may include a light projecting unit L3 and a light receiving unit R3. The light projecting unit L3 may be a projector. The light projecting unit L3 may be a projector that emits light of a predetermined wavelength of a near infrared area or an infrared area, as in the light projecting unit L1.

The attachment A4 illustrated in FIG. 2E may be a vein information collecting apparatus. A sensor unit Sen4 provided in the attachment A4 may be a vein capturing unit. The sensor unit Sen4 may include a light projecting unit L4 and a light receiving unit R4. The light projecting unit L4 may be a projector. The light projecting unit L4 may be a projector that emits light of a predetermined wavelength of a near infrared area or an infrared area, as in the light projecting unit L1. The attachment A4 may include a guide member AG4 that defines a predetermined range as the capturing range. The guide member AG4 is configured to maintain a focal length at the time of collection of vein information.

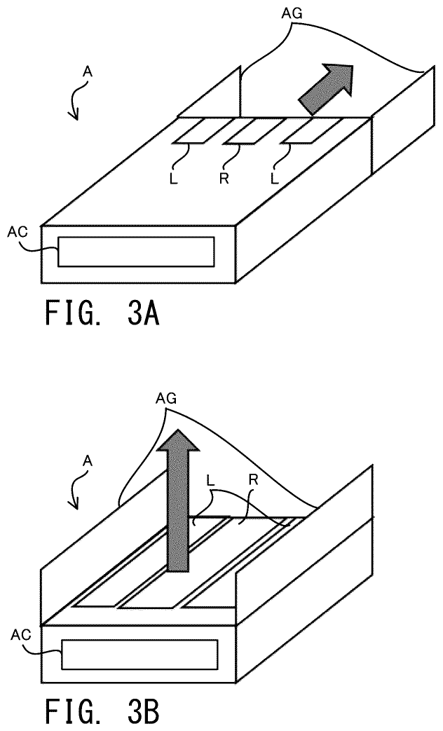

FIG. 3A and FIG. 3B illustrates a modified example of the attachment A. FIG. 3A and FIG. 3B illustrates an attachment A including a light projecting unit L, a light receiving unit R, and a guide member AG so as to direct light to a side opposite to a side where the connecting unit AC is provided (a side where the information acquisition apparatus D2 is disposed), as illustrated in FIG. 3A. That is, an illustrated configuration is, but is not limited to, a configuration in which light is directed in an arrow direction illustrated in FIG. 3A, the sensor unit Sen is provided to receive the light from the arrow direction, and the guide member AG is provided to guide these rays of light. For example, as illustrated in FIG. 3B, it may be an attachment A including the light projecting unit L, the light receiving unit R, and the guide member AG so as to direct light from a side adjacent to the side where the connecting unit AC is provided (a side where the information acquisition apparatus D2 is disposed). That is, it may be a configuration in which light is directed in an arrow direction illustrated in FIG. 3B, the sensor unit Sen is provided to receive the light from the arrow direction, and the guide member AG is provided to guide these rays of light. In FIG. 3B, the arrow is directed to an upper side of the drawing, but a configuration in which light is directed to a lower side of the drawing, a right side of the drawing, and a left side of the drawing, may be employed.

An irradiation direction of the light may vary for each attachment A. For example, the attachment A1, the attachment A2, and the attachment A3 employ the configuration illustrated in FIG. 3A, and the attachment A4 may employ the configuration illustrated in FIG. 3B.

Although not illustrated, the attachment A may be a voice recording apparatus including the sensor unit Sen having a microphone function. Alternatively, at least one of the attachment A1 to the attachment A4 described above is equipped with a microphone function, and may support voice collection.

In addition, the collection of facial information, iris information, fingerprint information, and vein information may be realized in one attachment A by using a lens in which a focal length is changeable by voltage. As the lens in which a focal length is changeable by voltage, a liquid crystal lens may be employed.

### [2-2: Configuration of Information Acquisition Apparatus D2]

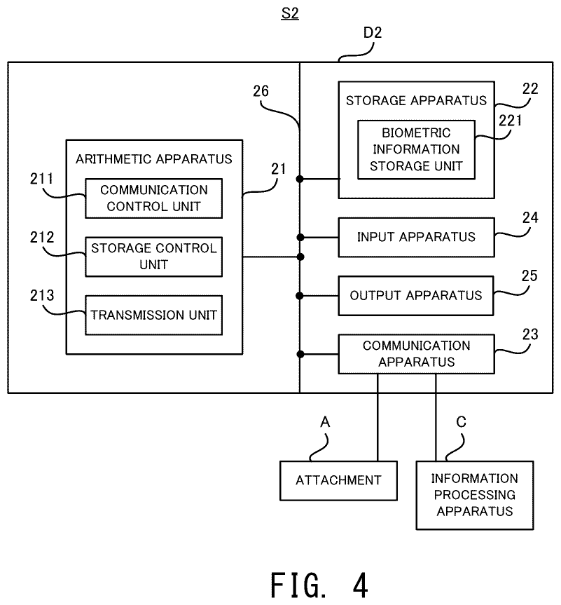

FIG. 4 is a block diagram illustrating a configuration of the information acquisition apparatus D2 in the second example embodiment. As illustrated in FIG. 4, the information acquisition apparatus D2 includes an arithmetic apparatus 21 and a storage apparatus 22. Furthermore, the information acquisition apparatus D2 may include a communication apparatus 23, an input apparatus 24, and an output apparatus 25. The information acquisition apparatus D2, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26.

The arithmetic apparatus 21 includes at least one of a CPU (Central Processing Unit), a GPU (Graphics Processing Unit), and a FPGA (Field Programmable Gate Array), for example. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the information acquisition apparatus D2 (e.g., the input apparatus 24 described later). The arithmetic apparatus 21 may acquire (i.e., download or read) a computer program from a not-illustrated apparatus disposed outside the information acquisition apparatus D2 via the communication apparatus 23 (or another communication apparatus). The arithmetic apparatus 21 executes the read computer program. Consequently, a logical functional block for performing an operation to be performed by the information acquisition apparatus D2 is realized or implemented in the arithmetic apparatus 21. That is, the arithmetic apparatus 21 is allowed to function as a controller for realizing a logical functional block for performing an operation (in other words, processing) to be performed by the information acquisition apparatus D2.

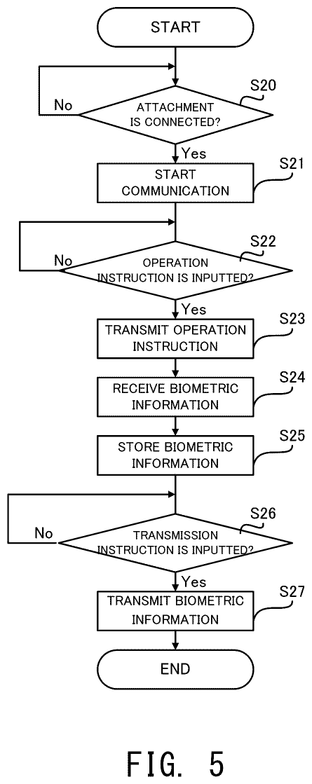

FIG. 4 illustrates an example of the logical functional block realized or implemented in the arithmetic apparatus 21 to perform an information acquisition operation. As illustrated in FIG. 4, a communication control unit 211, a storage control unit 212, and a transmission unit 213 that is a specific example of the “transmission unit” described later in Supplementary Note, are realized or implemented in the arithmetic apparatus 21. At least one of the communication control unit 211 and the storage control unit 212, however, may not be realized or implemented in the arithmetic apparatus 21. Details of operation of each of the communication control unit 211, the storage control unit 212, and the transmission unit 213 will be described in detail later with reference to FIG. 5.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the information acquisition apparatus D2 for a long time. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium. The storage apparatus 22 includes a biometric information storage unit 221 that is a specific example of the “storage unit” described later in Supplementary Note.

The communication apparatus 23 is configured to communicate with an apparatus external to the information acquisition apparatus D2 via a not-illustrated communication network. The communication apparatus 23 may be a communication interface based on a standard such as Ethernet, Wi-Fi, Bluetooth, and USB (Universal Serial Bus). The information acquisition apparatus D2 may transmit and receive signals to and from at least one of the attachment A and the information processing apparatus C via the communication apparatus 23.

The input apparatus 24 is an apparatus that receives an input of information to the information acquisition apparatus D2 from an outside of the information acquisition apparatus D2. In the second example embodiment, the input apparatus 24 may include the collection button CB and the transmit button SB. Furthermore, for example, the input apparatus 24 may include an operating apparatus (e.g., at least one of a keyboard, a mouse, and a touch panel) that is operable by an operator of the information acquisition apparatus D2. In addition, for example, the input apparatus 24 may include a reading apparatus that is configured to read information recorded as data on a recording medium that is externally attachable to the information acquisition apparatus D2.

The output apparatus 25 is an apparatus that outputs information to the outside of the information acquisition apparatus D2. For example, the output apparatus 25 may output information as an image. That is, the output apparatus 25 may include a display apparatus (a so-called display) that is configured to display an image indicating the information that is desirably outputted. For example, the output apparatus 25 may output information as audio/sound. That is, the output apparatus 25 may include an audio apparatus (a so-called speaker) that is configured to output audio/sound. For example, the output apparatus 25 may output information onto a paper surface. That is, the output apparatus 25 may include a print apparatus (a so-called printer) that is configured to print desired information on the paper surface.

### [2-3: Information Acquisition Operation Performed by Information Acquisition Apparatus D2]

Next, with reference to FIG. 5, an information acquisition operation performed by the information acquisition apparatus D2 in the second example embodiment will be described. FIG. 5 is a flowchart illustrating a flow of the information acquisition operation performed by the information acquisition apparatus D2 in the second example embodiment.

As illustrated in FIG. 5, when the connecting unit 11 and the connecting unit AC are connected, and the information acquisition apparatus D2 and the attachment A are thus connected (step S20: Yes), the communication control unit 211 starts communication with the attachment A (step S21).

When the collection button CB receives an input of an operation instruction to the attachment A (step S22: Yes), the communication control unit 211 transmits the operation instruction to the attachment A, in response to the input of the operation instruction to the attachment A, which is received by the collection button CB (step S23).

The communication control unit 211 receives the biometric information acquired by the attachment A (step S24), and the storage control unit 212 stores the biometric information acquired by the attachment A in the biometric information storage unit 221 (step S25).

When the send button SB receives an input of an instruction to transmit the biometric information to the information processing apparatus C (step S26: Yes), the transmission unit 213 transmits the biometric information stored in the biometric information storage unit 221, to the information processing S27 (step S27).

### [2-4: Technical Effect of Information Acquisition System S2]

The information acquisition apparatus D2 in the second example embodiment is carriable with one hand and has the send button SB that receives the input of the operation instruction. Therefore, it has good operability of the operator.

For example, in the technical example described in Patent Literature 3 serving as a comparative example, a replacement/attachment part is limited to the light source unit for personal authentication, and it is not designed to be replaced, including an image capturing unit. Therefore, it is hardly possible to deal with situations in which it is required to change technological advances and industry standards, to change application in facial authentication in ultra-short focus shooting or the like, and to enhance or change resolution of the image capturing unit itself based on an imaging target. In addition, in the technical example of Patent Literature 4 serving as a comparative example, an image capturing unit itself has a mechanism for directing UV rays, and an irradiation target part is limited to the image capturing unit on which an imaging target person places his/her finger. Thus, the other part is unsterilized. This is insufficient from a viewpoint of preventing an infectious disease. Furthermore, an UV ray control apparatus is attached to all the devices, and directs UV rays without controlling electricity consumption when the finger is not detected. Therefore, it is not possible to disinfect a plurality of devices at a time, when needed, which is inefficient. Furthermore, since UV irradiation cannot be confirmed, there are safety concerns if the UV rays are constantly directed in the event of a malfunction.

In contrast, in the information acquisition system S2 in the second example embodiment, it is possible to perform at least one of disinfection by UV irradiation and disinfection by heat including boiling, on a whole detachable part, i.e., the whole attachment A. For example, in a case where the biometric information is acquired from a plurality of target parts of a certain living body, the plurality of attachments A may be collectively disinfected after use. Since it is possible to perform at least one of the disinfection by UV irradiation and the disinfection by heat including boiling, on the plurality of attachments A, collectively, for each living body, it is possible to maintain a sanitary condition even when an unspecified number of people use the same device. Since it is possible to disinfect the whole attachment A including a place where a living body may touch, it is effective particularly when the attachment A is used in contact with the target part.

### 3: Third Example Embodiment

Next, an information acquisition apparatus, an information acquisition system, an information processing system, an information acquisition method, and a recording medium according to a third example embodiment will be described. The following describes the information acquisition apparatus, the information acquisition system, the information processing system, the information acquisition method, and the recording medium according to the third example embodiment, by using an information acquisition system S3 to which the information acquisition apparatus, the information acquisition system, the information processing system, the information acquisition method, and the recording medium according to the third example embodiment are applied.

The information acquisition system S3 in the third example embodiment may include an information acquisition apparatus D3 and a plurality of attachments A, as in the information acquisition system S2 in the second example embodiment.

### [3-1: Configuration of Information Acquisition Apparatus D3]

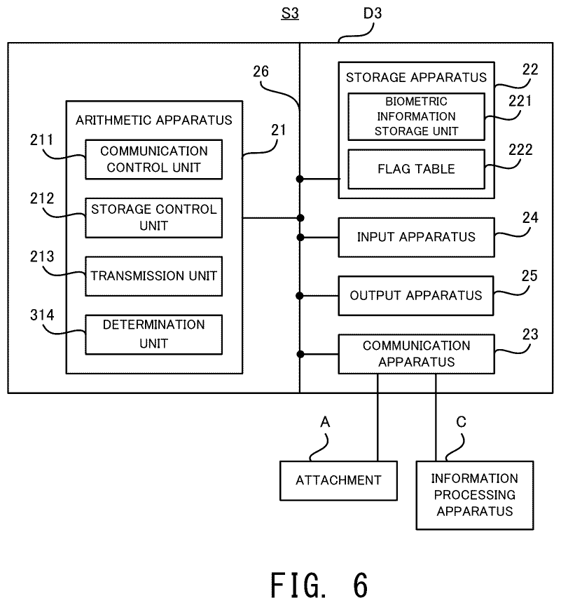

As illustrated in FIG. 6, the information acquisition apparatus D3 in the third example embodiment includes the arithmetic apparatus 21 and the storage apparatus 22, as in the information acquisition apparatus D2 in the second example embodiment. Furthermore, the information acquisition apparatus D3 in the third example embodiment may include the communication apparatus 23, the input apparatus 24, and the output apparatus 25, as in the information acquisition apparatus D2 in the second example embodiment. The information acquisition apparatus D3, however, may not include at least one of the communication apparatus 23, the input apparatus 24, and the output apparatus 25. The information acquisition apparatus D3 in the third example embodiment differs from the information acquisition apparatus D2 in the second example embodiment, in that the arithmetic apparatus 21 further includes a determination unit 314. In the information acquisition apparatus D3, the storage apparatus 22 may include a flag table 222. The flag table 222 associates and stores therein attachment identification information for identifying the attachment A and flag information serving as identification information indicating a type of the biometric information that is acquirable by the attachment A. Other features of the information acquisition apparatus D3 may be the same as those of the information acquisition apparatus D2 in the second example embodiment. For this reason, a part differing from each of the example embodiments described above will be described in detail below; and a description of the other overlapping parts will be omitted as appropriate.

The attachment A in the third example embodiment holds the attachment identification information for identifying the attachment A, and presents the attachment identification information to the information acquisition apparatus D3 when it is connected to the information acquisition apparatus D3.

### [3-2: Information Acquisition Operation Performed by Information Acquisition Apparatus D3]

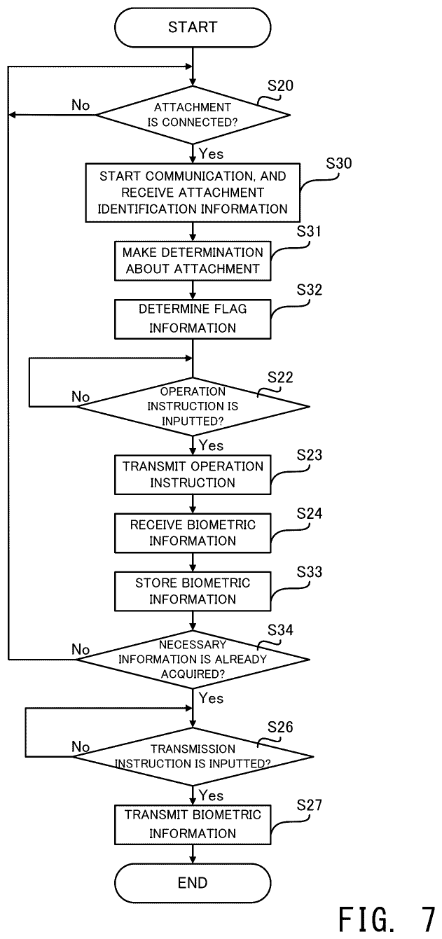

Next, with reference to FIG. 7, an information acquisition operation performed by the information acquisition apparatus D3 in the third example embodiment will be described. FIG. 7 is a flowchart illustrating a flow of the information acquisition operation performed by the information acquisition apparatus D3 in the third example embodiment.

As illustrated in FIG. 7, when the information acquisition apparatus D3 and the attachment A are connected (step S20: Yes), the communication control unit 211 starts communication with the attachment A, and the communication control unit 211 acquires the attachment identification information presented by the attachment A (step S30).

The determination unit 314 determines to which attachment A the information acquisition apparatus D3 is connected, based on the attachment identification information (step S31). The determination unit 314 refers to the flag table 222 exemplified in Table 1 below, and determines to which flag information the connected attachment A corresponds (step S32).

TABLE 1
[Flag Table]

| ATTACHMENT | |
|---|---|
| IDENTIFICATION INFORMATION | FLAG INFORMATION |
| A1 | 1 |
| A2 | 2 |
| A3 | 3 |
| A4 | 4 |

As exemplified in Table 1 above, for example, when the attachment A is an iris information acquisition apparatus, the attachment identification information may be “A1” and the flag information indicating the iris information may be “1.” When the attachment A is a facial information acquisition apparatus, the attachment identification information may be “A2” and the flag information indicating the facial information may be “2”. When the attachment A is a fingerprint information acquisition apparatus, the attachment identification information may be “A3” and the flag information indicating the fingerprint information may be “3”. When the attachment A is a vein information acquisition apparatus, the attachment identification information may be “A4” and the flag information indicating the vein information may be “4.”

The storage control unit 212 associates and stores, in the biometric information storage unit 221, the biometric information and the flag information indicating the type of the biometric information that is acquirable by the attachment A determined by the determination unit 314 (step S33). That is, the flag information capable of identifying which type of biometric information is added to the biometric information. For example, when the attachment A is the fingerprint information acquisition apparatus, “4” indicating the fingerprint information is added to the biometric information acquired from the attachment A. The biometric information storage unit 221 may include storage areas that are divided for each type of biometric information, for example.

The storage control unit 212 determines whether or not all the necessary biometric information is stored (step S34). For example, when the iris information and the fingerprint information are required, it is determined whether both the iris information and the fingerprint information are stored in the biometric information storage unit 221.

When the storage of all the necessary biometric information is not completed (the step S34: No), the process returns to the step S20 to collect the necessary biometric information. In this instance, as described in a subsequent example embodiment, the information acquisition apparatus D3 may encourage an operator of the information acquisition apparatus D3 to connect the attachment A for acquiring the necessary biometric information, to the information acquisition apparatus D3.

When all the necessary biometric information is stored (the step S34: Yes), the step S26 and the step S27 are performed.

The storage control unit 212 may collectively store pieces of biometric information collected from a plurality of collection target parts of a living body. The transmission unit 213 may collectively transmit the pieces of biometric information collected from the living body, to the information processing apparatus C. It is thus possible to reduce errors, such as mix-up of information on different living bodies.

### [3-3: Technical Effect of Information Acquisition System S3]

The information acquisition system S3 in the third example embodiment is configured to accurately distinguish from which target part the biometric information is collected, even when acquiring a plurality of types of biometric information.

### 4: Fourth Example Embodiment

Next, an information acquisition apparatus, an information acquisition system, an information processing system, an information acquisition method, and a recording medium according to a fourth example embodiment will be described. The following describes the information acquisition apparatus, the information acquisition system, the information processing system, the information acquisition method, and the recording medium according to the fourth example embodiment, by using an information acquisition system S4 to which the information acquisition apparatus, the information acquisition system, the information processing system, the information acquisition method, and the recording medium according to the fourth example embodiment are applied.

The information acquisition system S4 in the fourth example embodiment may include an information acquisition apparatus D4 and a plurality of attachments A, as in the information acquisition system S2 in the second example embodiment and the information acquisition system S3 in the third example embodiment. A configuration of the information acquisition apparatus D4 in the fourth example embodiment may be the same as that of the information acquisition apparatus D3 in the third example embodiment illustrated in FIG. 6.

### [4-1: External View of Information Acquisition System S4]

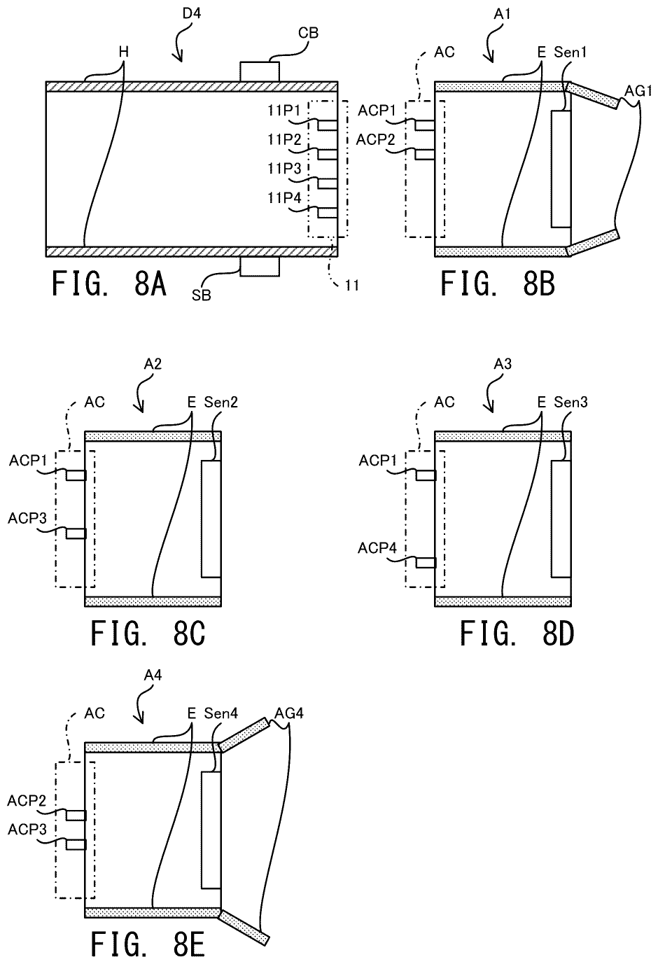

As illustrated in FIG. 8A, the connecting unit 11 has a plurality of concave parts 11P. The concave part 11P may be a pinhole. For example, the connecting unit 11 may have a first pinhole 11P1 to a fourth pinhole 11P4.

The connecting unit AC has at least one convex part ACP unique to the attachment A. The at least one convex part ACP may be a pin in which at least one of a position and a number of the convex parts is fixed for each attachment A. As illustrated in FIG. 8B, for example, the attachment A1 may have a pin ACP1 and a pin ACP2 corresponding to the first pinhole 11P1 and the second pinhole 11P2. Furthermore, as illustrated in FIG. 8C, for example, the attachment A2 may have a pin ACP1 and a pin ACP3 corresponding to the first pinhole 11P1 and the third pinhole 11P3. Furthermore, as illustrated in FIG. 8D, for example, the attachment A3 may have a pin ACP1 and a pin ACP4 corresponding to the first pinhole of 11P1 and the fourth pinhole 11P4. Furthermore, as illustrated in FIG. 8E, for example, the attachment A4 may have a pin ACP2 and a pin ACP3 corresponding to the second pinhole 11P2 and the third pinhole 11P3.

### [4-2: Information Acquisition Operation Performed by Information Acquisition Apparatus D4]

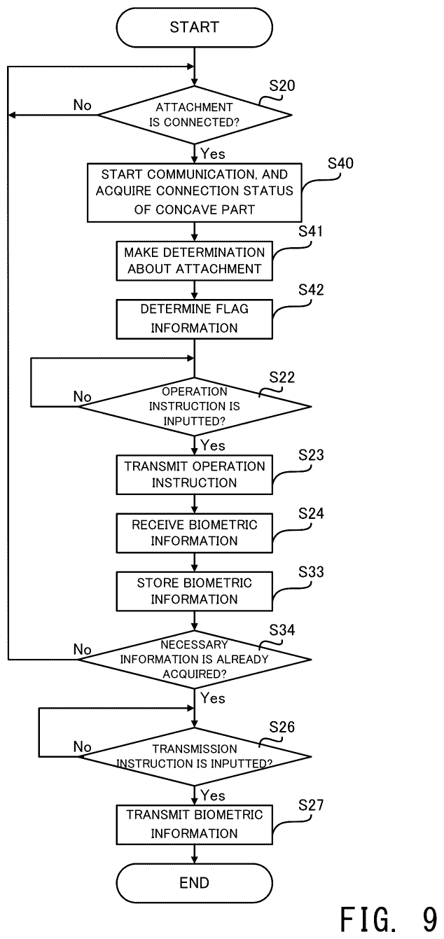

Next, with reference to FIG. 9, an information acquisition operation performed by the information acquisition apparatus D4 in the fourth example embodiment will be described. FIG. 9 is a flowchart illustrating a flow of the information acquisition operation performed by the information acquisition apparatus D4 in the fourth example embodiment. As illustrated in FIG. 9, when the information acquisition apparatus D4 and the attachment A are connected (step S20: Yes), the communication control unit 211 starts communication with the attachment A, and the communication control unit 211 acquires connection status information indicating which of the plurality of concave parts 11P is connected to the convex part ACP (step S40).

The determination unit 314 determines which attachment A is connected, based on the connection status information (step S41). The determination unit 314 refers to the flag table 222 exemplified in Table 2 below; and determines to which flag information the connected attachment A corresponds (step S42).

TABLE 2
[Flag Table]

| CONNECTION STATUS INFORMATION | FLAG INFORMATION |
|---|---|
| 1 and 2 | 1 |
| 1 and 3 | 2 |
| 1 and 4 | 3 |
| 2 and 3 | 4 |

As exemplified in Table 2 above, for example, when the attachment A is the attachment A1, the concave part 11P to be connected to the convex part ACP is “first (1)” and “second (2)”, and may be associated with “1” indicating the iris information. Furthermore, when the attachment A is the attachment A2, the concave part 11P to be connected to the convex part ACP is “first (1)” and “third (3)”, and may be associated with “2” indicating the facial information. Furthermore, when the attachment A is the attachment A3, the concave part 11P to be connected to the convex part ACP is “first (1)” and “fourth (4)”, and may be associated with “3” indicating the fingerprint information. Furthermore, when the attachment A is the attachment A4, the concave part 11P to be connected to the convex part ACP is “second (2)” and “third (3)”, and may be associated with “4” indicating the vein information.

The operation after the step S22 may be the same as the information acquisition operation in the third example embodiment described with reference to FIG. 7.

### [4-3: Technical Effect of Information Acquisition System S4]

The information acquisition system S4 in the fourth example embodiment is configured to accurately distinguish from which target part the biometric information is collected, even when acquiring a plurality of types of biometric information.

### 5: Fifth Example Embodiment

Next, an information acquisition apparatus, an information acquisition system, an information processing system, an information acquisition method, and a recording medium according to a fifth example embodiment will be described. The following describes the information acquisition apparatus, the information acquisition system, the information processing system, the information acquisition method, and the recording medium according to the fifth example embodiment, by using an information acquisition system S5 to which the information acquisition apparatus, the information acquisition system, the information processing system, the information acquisition method, and the recording medium according to the fifth example embodiment are applied.

The information acquisition system S5 in the fifth example embodiment differs from the other example embodiments, in a method of changing a connection between an information acquisition apparatus D5 and the attachment A. Other features of the information acquisition apparatus D5 in the fifth example embodiment may be the same as those of at least one of the information acquisition apparatus D2 in the second example embodiment to the information acquisition apparatus D4 in the fourth example embodiment.

### [5-1: External View of Information Acquisition System S5]

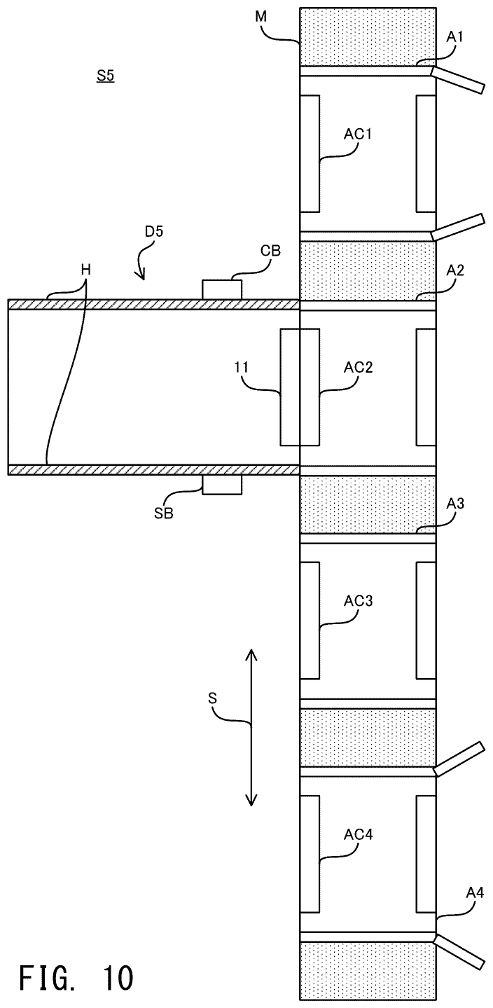

As illustrated in FIG. 10, the information acquisition system S5 in the fifth example embodiment includes a mounting part M. The mounting part M is equipped with a plurality of types of attachments A. In a case illustrated in FIG. 10, it is equipped with the attachment A1, the attachment A2, the attachment A3, and the attachment A4. A relative positional relation is changeable between the mounting part M and the connecting unit 11.

By changing the relative positional relation between the mounting part M and the connecting unit 11, it is possible to change the attachment A to be connected to the information acquisition apparatus D5. The change in the relative positional relation between the mounting part M and the connecting unit 11, makes it possible to connect the connecting unit 11 to the connecting unit AC of any one of the attachments A. FIG. 10 illustrates a state in which the connecting unit 11 and a connecting unit AC2 are connected and the attachment A2 is operable.

The mounting part M may be bar-shaped. That is, the relative positional relation in a linear direction may be changed between the mounting part M and the connecting unit 11. As illustrated in FIG. 10, the information acquisition apparatus D5 and the mounting part M may be relatively moved in a direction of an arrow S, the connecting unit 11 may be connected to any one of a connecting unit AC1 to a connecting unit AC4, and the attachment A corresponding to the connected connecting unit AC may be operated.

The mounting part M may be circular or arcuate. That is, the relative positional relation in a rotation direction may be changed between the mounting part M and the connecting unit 11.

For example, depending on how an operator holds the holding part H, the positional relation between the information acquisition apparatus D5 and the mounting part M may be automatically changed. For example, in a case where the mounting part M is bar-shaped and the operator holds the holding part H such that a longitudinal direction of the mounting part M is perpendicular, the positional relation may be changed to a positional relation in which the connecting unit 11 and the attachment A1 located uppermost are connected.

Furthermore, depending on how the operator holds the holding part H, the availability of a predetermined attachment A may be changed. For example, in a case where the mounting part M is bar-shaped and the operator holds the holding part H such that the longitudinal direction of the mounting part M is perpendicular, the availability of the attachment A1 and the attachment A2 may be changed to be usable, and the availability of the attachment A3 and the attachment A4 may be changed to be unusable. Furthermore, in a case where the mounting part M is bar-shaped and the operator holds the holding part H such that the longitudinal direction of the mounting part M is horizontal, the availability of the attachment A3 and the attachment A4 may be changed to be usable, and the availability of the attachment A1 and the attachment A2 may be changed to be unusable.

### [5-2: Technical Effect of Information Acquisition System S5]

In the information acquisition system S5 in the fifth example embodiment, it is possible to smoothly change the attachment A by the method of changing the connection between the information acquisition apparatus D5 and the attachment A.

### 6: Sixth Example Embodiment

Next, an information acquisition apparatus, an information acquisition system, an information processing system, an information acquisition method, and a recording medium according to a sixth example embodiment will be described. The following describes the information acquisition apparatus, the information acquisition system, the information processing system, the information acquisition method, and the recording medium according to the sixth example embodiment, by using an information acquisition system S6 to which the information acquisition apparatus, the information acquisition system, the information processing system, the information acquisition method, and the recording medium according to the sixth example embodiment are applied.

### [6-1: Configuration of Information Acquisition Apparatus D6]

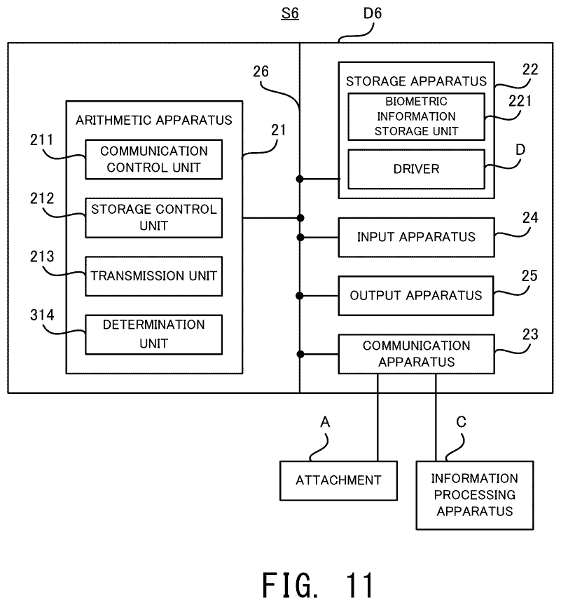

As illustrated in FIG. 11, an information acquisition apparatus D6 in the sixth example embodiment includes the arithmetic apparatus 21 and the storage apparatus 22, as in the information acquisition apparatus D2 in the second example embodiment to the information acquisition apparatus D5 in the fifth example embodiment. Furthermore, the information acquisition apparatus D6 in the sixth example embodiment may include the communication apparatus 23, the input apparatus 24, and the output apparatus 25, as in the information acquisition apparatus D2 in the second example embodiment to the information acquisition apparatus D5 in the fifth example embodiment. The information acquisition apparatus D6, however, may not include at least one of the communication apparatus 23, the input apparatus 24, and the output apparatus 25. The information acquisition apparatus D6 in the sixth example embodiment differs from the information acquisition apparatus D2 in the second example embodiment to the information acquisition apparatus D5 in the fifth example embodiment, in that the storage apparatus 22 further stores a driver D. The storage apparatus 22 stores the driver D corresponding to each of the attachments A that are connectable to the information acquisition apparatus D6. The arithmetic apparatus 21 provided in the information acquisition apparatus D6 may include the determination unit 314. Other features of the information acquisition apparatus D6 may be the same as those of at least one of the information acquisition apparatus D2 in the second example embodiment to the information acquisition apparatus D5 in the fifth example embodiment. For this reason, a part differing from each of the example embodiments described above will be described in detail below; and a description of the other overlapping parts will be omitted as appropriate.

### [6-2: Information Acquisition Operation Performed by Information Acquisition Apparatus D6]

In the sixth example embodiment, when the connecting unit 11 and the connecting unit AC are connected and the information acquisition apparatus D6 and the attachment A are thus connected, the communication control unit 211 may acquire the attachment identification information from the attachment A. and the determination unit 314 may determine which attachment A is connected, based on the attachment identification information. Alternatively, the communication control unit 211 may acquire the connection status information indicating which of the plurality of concave parts 11P is connected to the convex part ACP, and the determination unit 314 may determine which attachment A is connected, based on the connection status information. The communication control unit 211 operates the attachment A by using the driver D corresponding to the attachment A, in accordance with the determination by the determination unit 314.

### [6-3: Technical Effect of Information Acquisition System S6]

According to the information acquisition system S6 in the sixth example embodiment, since the driver D is included in the information acquisition apparatus D6, it is possible to stably operate the attachment even when changing the attachment A.

### 7: Seventh Example Embodiment

Next, an information acquisition apparatus, an information acquisition system, an information processing system, an information acquisition method, and a recording medium according to a seventh example embodiment will be described. The following describes the information acquisition apparatus, the information acquisition system, the information processing system, the information acquisition method, and the recording medium according to the seventh example embodiment, by using an information processing system SYS7 to which the information acquisition apparatus, the information acquisition system, the information processing system, the information acquisition method, and the recording medium according to the seventh example embodiment are applied.

### [7-1: Configuration of Information Processing System SYS7]

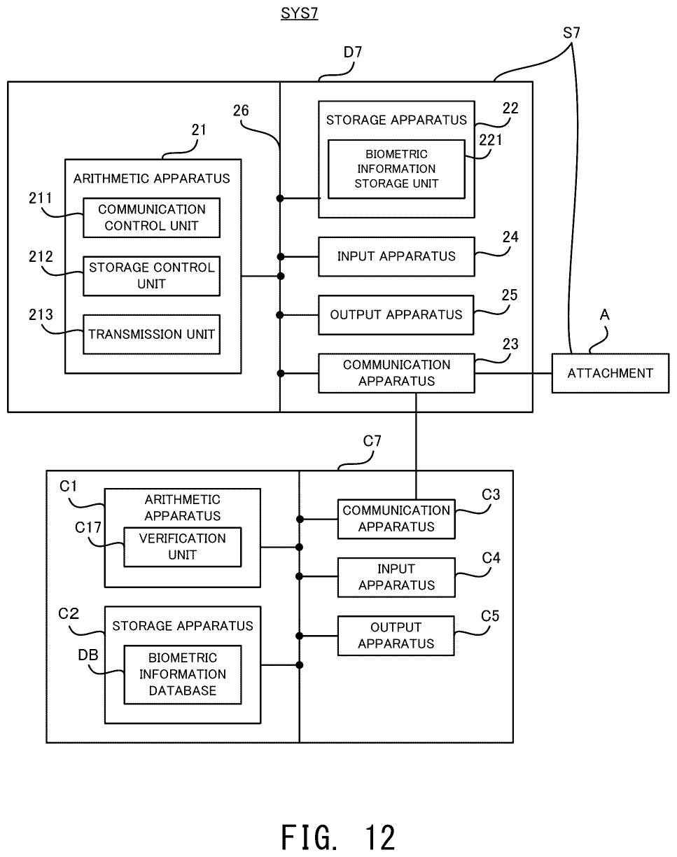

As illustrated in FIG. 12, the information processing system SYS7 includes an information acquisition system S7 and an information processing apparatus C7. The information acquisition system S7 in the seventh example embodiment may be the same as at least one of the information acquisition system S2 in the second example embodiment to the information acquisition system S6 in the sixth example embodiment.

As illustrated in FIG. 12, the information processing apparatus C7 may include an arithmetic apparatus C1, a storage apparatus C2, a communication apparatus C3, an input apparatus C4, and an output apparatus C5. The arithmetic apparatus C1, the storage apparatus C2, the communication apparatus C3, the input apparatus C4, and the output apparatus C5 may be connected via a data bus C6.

The arithmetic apparatus C1 includes at least one of a CPU (Central Processing Unit), a GPU (Graphics Processing Unit), and a FPGA (Field Programmable Gate Array), for example. The arithmetic apparatus C1 reads a computer program. For example, the arithmetic apparatus C1 may read a computer program stored in the storage apparatus C2. For example, the arithmetic apparatus C1 may read a computer program stored by a computer-readable and non-transitory recording medium, by using a not-illustrated recording medium reading apparatus provided in the information processing apparatus C7 (e.g., the input apparatus C4 described later). The arithmetic apparatus C1 may acquire (i.e., download or read) a computer program from a not-illustrated apparatus disposed outside the information processing apparatus C7 via the communication apparatus C3 (or another communication apparatus). The arithmetic apparatus C1 executes the read computer program. Consequently, a logical functional block for performing an operation to be performed by the information processing apparatus C7 is realized or implemented in the arithmetic apparatus C1. That is, the arithmetic apparatus C1 is allowed to function as a controller for realizing or implementing the logical functional block for performing an operation (in other words, processing) to be performed by the information processing apparatus C7.

The storage apparatus C2 is configured to store desired data. For example, the storage apparatus C2 may temporarily store a computer program to be executed by the arithmetic apparatus C1. The storage apparatus C2 may temporarily store data that are temporarily used by the arithmetic apparatus C1 when the arithmetic apparatus C1 executes the computer program. The storage apparatus C2 may store data that are stored by the information processing apparatus C7 for a long time. The storage apparatus C2 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus C2 include a non-transitory recording medium. The storage apparatus C2 may include a biometric information database DB. The arithmetic apparatus C1 may realize or implement a verification unit C17. The verification unit C17 may collate/verify biometric information registered in the biometric information database DB with biometric information acquired from an information acquisition apparatus D7.

The communication apparatus C3 is configured to communicate with an apparatus external to the information processing apparatus C via a not-illustrated communication network. The communication apparatus C3 may be a communication interface based on a standard such as Ethernet. Wi-Fi, Bluetooth, and USB (Universal Serial Bus). The information processing apparatus C7 may transmit and receive signals to and from the information acquisition apparatus D7 via the communication apparatus C3.

The input apparatus C4 is an apparatus that receives an input of information to the information processing apparatus C7 from an outside of the information processing apparatus C7. For example, the input apparatus C4 may include an operating apparatus (e.g., at least one of a keyboard, a mouse, and a touch panel) that is operable by an operator of the information processing apparatus C7. For example, the input apparatus C4 may include a reading apparatus that is configured to read information recorded as data on a recording medium that is externally attachable to the information processing apparatus C7.

The output apparatus C5 is an apparatus that outputs information to the outside of the information processing apparatus C7. For example, the output apparatus C5 may output information as an image. In other words, the output apparatus C5 may include a display apparatus (a so-called display) that is configured to display an image indicating the information that is desirably outputted. For example, the output apparatus C5 may output information as audio/sound. That is, the output apparatus C5 may include an audio apparatus (a so-called speaker) that is configured to output audio/sound. For example, the output apparatus C5 may output information onto a paper surface. That is, the output apparatus C5 may include a print apparatus (a so-called printer) that is configured to print desired information on the paper surface.

### [7-2: Information Processing Operation Performed by Information Processing System SYS7]

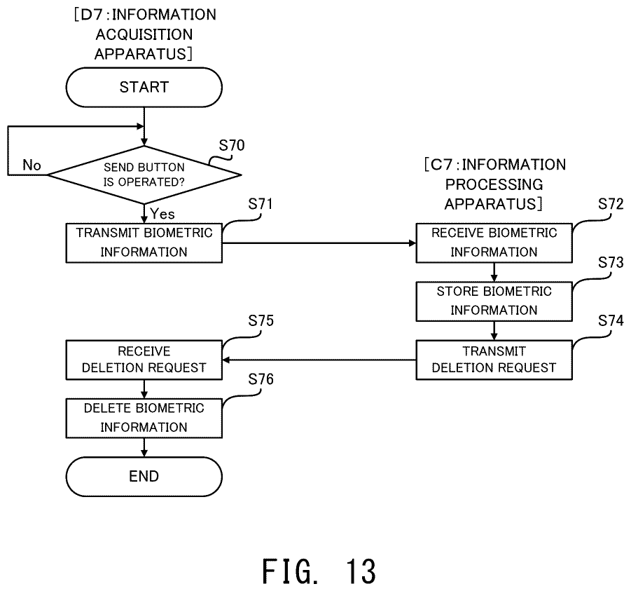

Next, with reference to FIG. 13, an information processing operation performed by the information processing system SYS7 in the seventh example embodiment will be described. FIG. 13 is a flowchart illustrating a flow of the information processing operation performed by the information processing SYS7 in the seventh example embodiment.

As illustrated in FIG. 13, when the send button SB is operated (step S70: Yes), the transmission unit 213 transmits the biometric information stored in the biometric information storage unit 221, to the information processing apparatus C7 (step S71). For example, in a case where a combination of desired pieces of biometric information on a single living body is stored in the biometric information storage unit 221, the send button SB may be operated. The transmission unit 213 may collectively transmit these pieces of biometric information to the information processing apparatus C7.

The information processing apparatus C7 receives the pieces of biometric information from the information acquisition apparatus D7 (step S72). The information processing apparatus C7 stores each of the received pieces of biometric information, with the same individual identification information added thereto (step S73). The information processing apparatus C7 stores the pieces of biometric information correctively transmitted, with the same individual identification information added thereto. The information processing apparatus C7 may store each of the received pieces of biometric information, in the biometric information database DB.

When a storage operation in the information processing apparatus C7 is completed, the information processing apparatus C7 transmits a deletion request signal to the information acquisition apparatus D7 (step S74). The communication control unit 211 receives a deletion request (step S75), and the storage control unit 212 deletes the biometric information in the biometric information storage unit 221 (step S76).

The transmission unit 213 may transmit the biometric information stored in the biometric information storage unit 221 when the connection with the information processing apparatus C7 is detected.

Furthermore, the storage control unit 212 may delete the biometric information temporarily stored in the biometric information storage unit 221 when the connection with the information processing apparatus C7 is cut off. The biometric information storage unit 221 may delete the biometric information stored in the biometric information storage unit 221 when the transmission unit 213 transmits the biometric information stored in the biometric information storage unit 221, to the information processing apparatus C7.

### [7-3: Technical Effect of Information Processing System SYS7]

In the information processing system SYS7 in the seventh example embodiment, since the information acquisition apparatus D7 and the information processing apparatus C7 collectively transmit and receive the biometric information collected from the same individual, there is no mix-up of biometric information. In addition, since the biometric information stored in the information acquisition apparatus D7 is deleted from the information acquisition apparatus D7 after the biometric information is transmitted from the information acquisition apparatus D7 to the information processing apparatus C7, it is possible to prevent theft of the biometric information.

### 8: Eighth Example Embodiment

Next, an information acquisition apparatus, an information acquisition system, an information processing system, an information acquisition method, and a recording medium according to an eighth example embodiment will be described. The following describes the information acquisition apparatus, the information acquisition system, the information processing system, the information acquisition method, and the recording medium according to the eighth example embodiment, by using an information processing system SYS8 to which the information acquisition apparatus, the information acquisition system, the information processing system, the information acquisition method, and the recording medium according to the eighth example embodiment are applied.

### [8-1: External View of Information Acquisition System S8]

In the eighth example embodiment, an information acquisition apparatus D8 includes a notification element 8E corresponding to each of a plurality of types of attachments A. The notification element 8E may give notice of an acquisition status of the biometric information that is acquirable from the corresponding attachment A, a connection status of the corresponding attachment A, or the like, by changing a lighting pattern or by developing a color. The notification element 8E may include a light emitting unit 8El and an illustration part 8Ei. The light emitting unit 8El may employ, for example, a light emitting diode (LED). The LED may be color-changeable. The illustration part 8Ei may be an illustration indicating a function of the attachment A. For example, a lighting manner of the light emitting unit 8El corresponding to the attachment A connected to the information acquisition apparatus D8 may be changed. In addition to or in place of this, the illustration part 8Ei corresponding to the attachment A connected to the information acquisition apparatus D8 may be highlighted.

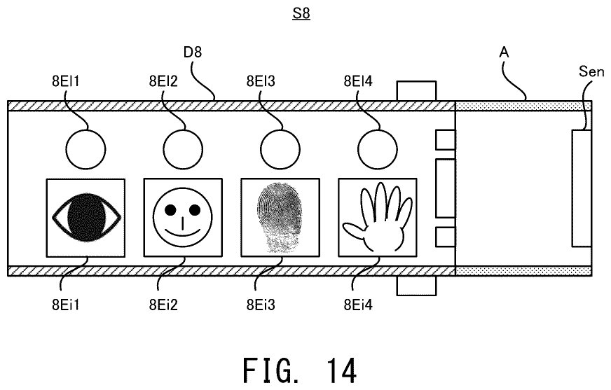

In the eighth example embodiment, the attachment A1, the attachment A2, the attachment A3, and the attachment A4 may be connectable to the information acquisition apparatus D8. In this case, as illustrated in FIG. 14, the information acquisition apparatus D8 may be provided with a light emitting unit 8El1 and an illustration part 8Ei1 corresponding to the attachment A1, a light emitting unit 8El2 and an illustration part 8Ei2 corresponding to the attachment A2, a light emitting unit 8El3 and an illustration part 8Ei3 corresponding to the attachment A3, and a light emitting unit 8El4 and an illustration part 8Ei4 corresponding to the attachment A4.

### [8-2: Configuration of Information Processing System SYS8]

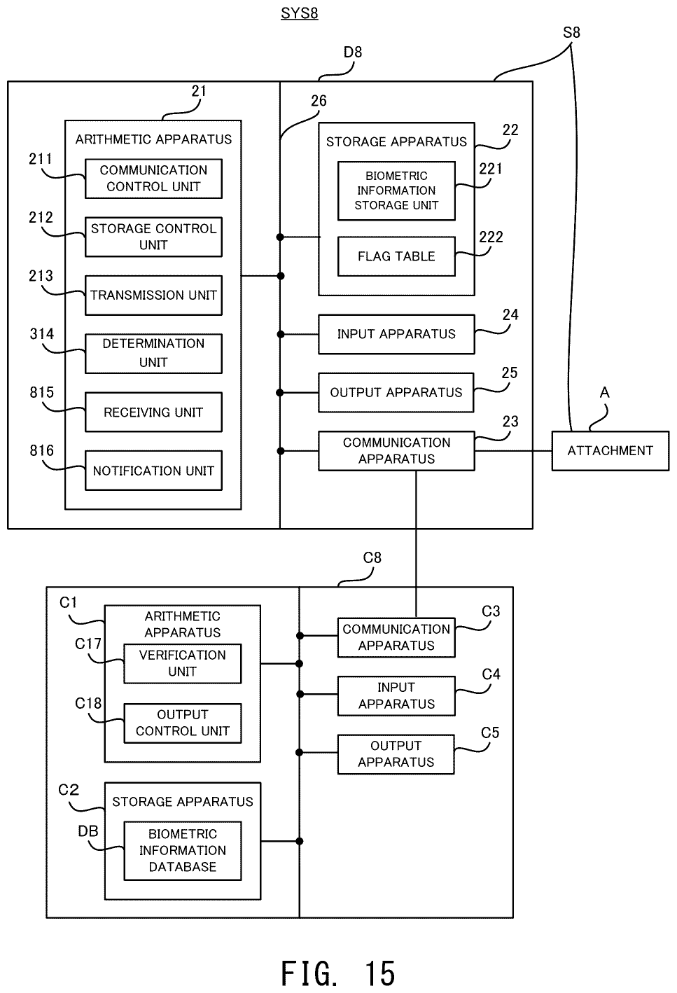

As illustrated in FIG. 15, the information acquisition apparatus D8 in the eighth example embodiment includes the arithmetic apparatus 21, and the storage apparatus 22, as in the information acquisition apparatus D2 in the second example embodiment to the information acquisition apparatus D7 in the seventh example embodiment. Furthermore, the information acquisition apparatus D8 in the eighth example embodiment may include the communication apparatus 23, the input apparatus 24, and the output apparatus 25, as in the information acquisition apparatus D2 in the second example embodiment to the information acquisition apparatus D7 in the seventh example embodiment. The information acquisition apparatus D8, however, may not include at least one of the communication apparatus 23, the input apparatus 24, and the output apparatus 25. The information acquisition apparatus D8 in the eighth example embodiment differs from the information acquisition apparatus D2 in the second example embodiment to the information acquisition apparatus D7 in the seventh example embodiment, in that the arithmetic apparatus 21 further includes a receiving unit 815 and a notification unit 816. The receiving unit 815 receives information indicating desired biometric information, from an information processing apparatus C8. The notification unit 816 controls a notification operation of the notification element 8E corresponding to each of a plurality of types of attachments A. Other features of the information acquisition apparatus D8 may be the same as those of at least one of the information acquisition apparatus D2 in the second example embodiment to the information acquisition apparatus D7 in the seventh example embodiment.

As illustrated in FIG. 15, the information processing apparatus C8 according to the eighth example embodiment may include the arithmetic apparatus C1, the storage apparatus C2, the communication apparatus C3, the input apparatus C4, and the output apparatus C5, as in the information processing apparatus C7 in the seventh example embodiment. The information processing apparatus C8 in the eighth example embodiment differs from the information processing apparatus C7 in the seventh example embodiment, in that the arithmetic apparatus C1 further includes an output control unit C18. The output control unit C18 may control the output apparatus C5 to output information about acquisition of the biometric information. Other features of the information processing apparatus C8 may be the same as those of the information processing apparatus C7 in the seventh example embodiment. For this reason, a part differing from each of the example embodiments described above will be described in detail below and a description of the other overlapping parts will be omitted as appropriate.

### [8-3: Information Processing Operation Performed by Information Processing System SYS8]

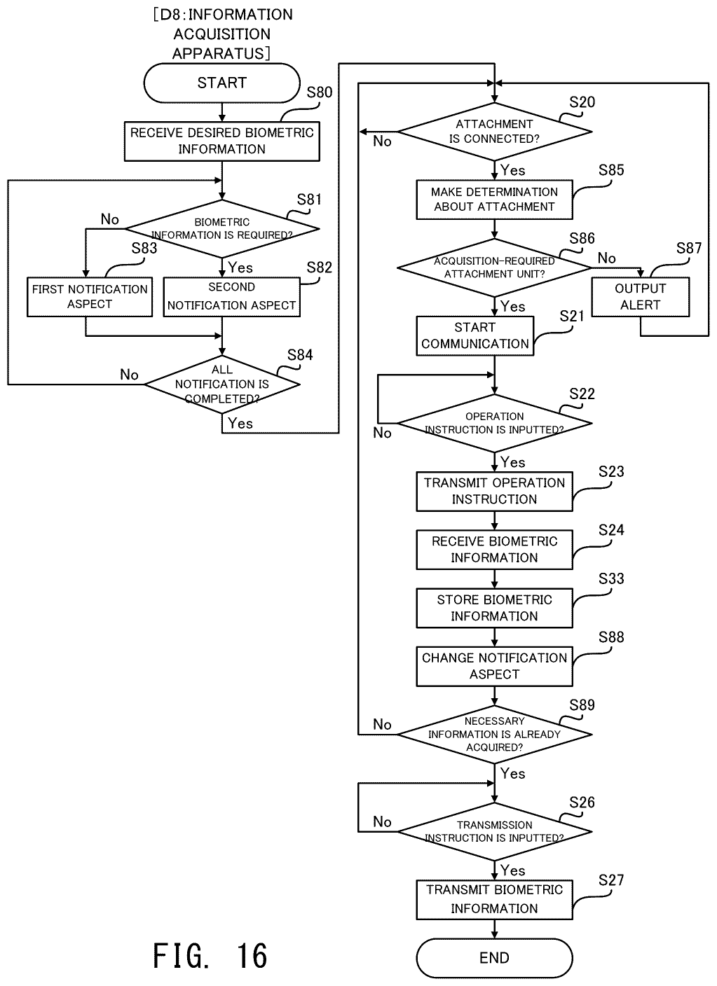

First, with reference to FIG. 16, an information processing operation performed by the information acquisition apparatus D8 in the eighth example embodiment will be described. FIG. 16 is a flowchart illustrating a flow of the information processing operation performed by the information acquisition apparatus D8 in the eighth example embodiment.

As illustrated in FIG. 16, the receiving unit 815 receives the information indicating the desired biometric information, from the information processing apparatus C8 (step S80). The receiving unit 815 may receive the information indicating the desired biometric information as exemplified in Table 3 below, from the information processing apparatus C8. The information indicating the desired biometric information may be associated with the individual identification information.

TABLE 3
[Information Indicating Desired Biometric Information]

| ATTACHMENT | |
|---|---|
| IDENTIFICATION INFORMATION | NECESSITY |
| A1 | NECESSARY |
| A2 | NECESSARY |
| A3 | NECESSARY |
| A4 | NOT NECESSARY |

Table 3 above exemplifies the followings: the iris information acquired by the attachment A with the attachment identification information of “A1”, i.e., the attachment A1, is “necessary”; the facial information acquired by the attachment A with the attachment identification information of “A2”, i.e., the attachment A2, is “necessary”; the fingerprint information acquired by the attachment A with the attachment identification information of “A3”, i.e., the attachment A3, is “necessary”; and the vein information acquired by the attachment A with the attachment identification information of “A4”, i.e., the attachment A4, is “not necessary”. As exemplified in Table 3 above, the information indicating the desired biometric information may include information about all the attachments A that are connectable to the information acquisition apparatus D8.

The notification unit 816 determines whether or not the acquisition of the biometric information is required, for each of the attachments A that are connectable to the information acquisition apparatus D8 (step S81). The notification unit 816 determines whether or not the acquisition of the biometric information is required for the attachment A1. In this case, the acquisition of the biometric information is required (the step S81: Yes), and the notification unit 816 causes the light emitting unit 8El1 corresponding to the attachment A1 to give notice in a second notification aspect (step S82). For example, the second notification manner may be a manner of turning on the light emitting unit 8El in a second color.

The notification unit 816 determines whether or not notification is completed for all of the attachments A that are connectable to the information acquisition apparatus D8 (step S84). When the notification is not completed for all of the attachments A that are connectable to the information acquisition apparatus D8 (the step S84: No), the process proceeds to the step S81.

The notification unit 816 determines whether or not the acquisition of the biometric information is required for the attachment A2. In this case, the acquisition of the biometric information is required (the step S81: Yes), and the notification unit 816 causes the light emitting unit 8El2 corresponding to the attachment A2 to give notice in the second notification manner (the step S82). The notification unit 816 determines whether or not the acquisition of the biometric information is required for the attachment A3. In this case, the acquisition of the biometric information is required (the step S81: Yes), and the notification unit 816 causes the light emitting unit 8El3 corresponding to the attachment A3 to give notice in the second notification manner (the step S82). The notification unit 816 determines whether or not the acquisition of the biometric information is required for the attachment A4. In this case, the acquisition of the biometric information is not required (the step S81: No), and the notification unit 816 causes the light emitting unit 8El4 corresponding to the attachment A4 to give notice in a first notification manner (step S83). For example, the first notification manner may be a manner of turning on the light emitting unit 8El in a first color.

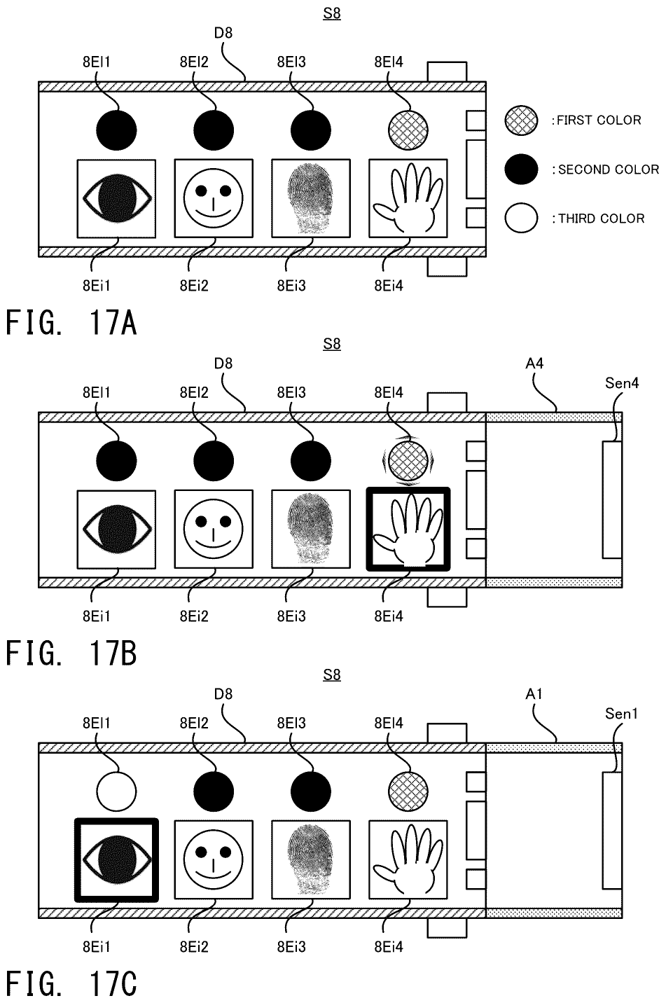

In a case where the information indicating the desired biometric information is the information exemplified in Table 3 above, the notification unit 816 may turn on the light emitting unit 8El1, the light emitting unit 8El2, and the light emitting unit 8El3 in the second color, and may turn on the light emitting unit 8El4 in the first color, as illustrated in FIG. 17A.

When the notification is completed for all of the attachments A that are connectable to the information acquisition apparatus D8 (the step S84: Yes), the process proceeds to step S20. When the information acquisition apparatus D8 and the attachment A are connected (the step S20: Yes), the determination unit 314 makes a determination about the attachment A (step S85). The determination unit 314 may make a determination about the attachment A. and may determine which is the notification element 8E corresponding to the attachment A. The notification unit 816 may change a display manner of the corresponding illustration part 8Ei. As illustrated in FIG. 17B, for example, in a case where the information acquisition apparatus D8 and the attachment A4 are connected, the notification unit 816 may change the display manner to emphasize the illustration part 8Ei4. Furthermore, for example, in a case where the information acquisition apparatus D8 and the attachment A1 are connected, as illustrated in FIG. 17C, the notification unit 816 may change the display manner to emphasize the illustration part 8Ei1.

The notification unit 816 determines whether or not the attachment A determined in the step S85 is the attachment A for which the acquisition of the biometric information is required (step S86). When the attachment A is the attachment A for which the acquisition of the biometric information is not required (the step S86: No), the notification unit 816 outputs an alert (step S87). As illustrated in FIG. 17B, for example, in a case where the information acquisition apparatus D8 and the attachment A4 are connected, the notification unit 816 may blink the light emitting unit 8El4 on and off. Furthermore, the notification unit 816 may transmit, to the information processing apparatus C8, information indicating that the attachment A for which the acquisition of the biometric information is not required is connected to the information acquisition apparatus D8. The output control unit C18 may cause the output apparatus C5 to output the information indicating that the attachment A for which the acquisition of the biometric information is not required is connected to the information acquisition apparatus D8. In particular, in a case where the information processing apparatus C8 and the information acquisition apparatus D8 are located far apart, it is preferable that the notification is possible in both the information processing apparatus C8 and the information acquisition apparatus D8. After outputting an alert, the process proceeds to the step S20.

When the attachment A is the attachment A for which the acquisition of the biometric information is required (the step S86: Yes), and when the collection button CB receives an input of an operation instruction to the attachment A (step S22: Yes), the communication control unit 211 transmits the operation instruction (step S23) and receives the biometric information (step S24). The storage control unit 212 stores the biometric information (step S33).

The storage control unit 212 associates and stores, in the biometric information storage unit 221, the biometric information and the flag information indicating the type of the biometric information that is acquirable by the attachment A determined by the determination unit 314. The notification unit 816 causes the light emitting unit 8El corresponding to the attachment A, to give notice in a third notification manner (step S88). That is, when the biometric information that is acquirable by the attachment A is stored, the notification unit 816 changes the notification manner of the light emitting unit 8El corresponding to the attachment A from the second notification manner to the third notification manner. For example, the third notification manner may be a manner of turning on the light emitting unit 8El in a third color. The notification unit 816 causes each of the notification element 8E to give notice such that the first notification manner, the second notification manner, and the third notification manner differ from each other. For example, in a case where the information acquisition apparatus D8 and the attachment A1 are connected and the iris information is stored, as illustrated in FIG. 17C, the notification unit 816 changes the notification manner of the light emitting unit 8El1 from the second notification manner to the third notification manner.

The notification unit 816 determines whether or not the desired biometric information is all acquired (step S89). When the desired biometric information is all acquired (the step S89: Yes), the process proceeds to step S26. When the acquisition of all the desired biometric information is not completed (the step S89: No), the process proceeds to the step S20.

A case where the desired biometric information is all acquired may be a case where there is no light emitting unit 8El in the second notification manner. When there is no light emitting unit 8El in the second notification manner, the information acquisition apparatus D8 may perform such a control as allowing the send button SB to be operated. When the desired biometric information is all acquired (the step S89: Yes), the information acquisition apparatus D8 may enable an operation of the send button SB. Alternatively, when the acquisition of all the desired biometric information is not completed (the step S89: No), the information acquisition apparatus D8 may disable the operation of the send button SB

When the desired biometric information is all acquired, the output control unit C18 may cause the output apparatus C5 to output guidance indicating that the biometric information is completely acquired. In addition, when the send button SB is operated despite the light emitting unit 8El in the second notification manner, the output control unit C18 may cause the output apparatus C5 to output an alert indicating that biometric information is not completely acquired. In the step S27, the information acquisition apparatus D8 may transmit, to the information processing apparatus C8, the acquired desired biometric information associated with the individual identification information.

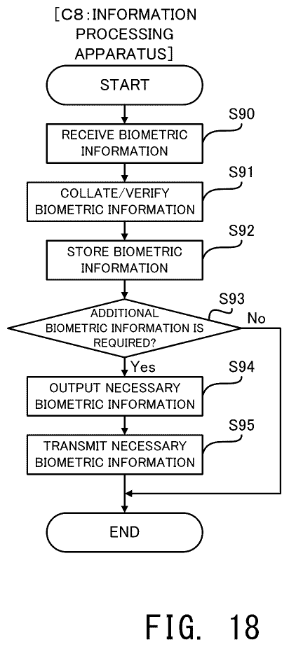

Referring now to FIG. 18, an information processing operation performed by the information processing apparatus C8 in the eighth example embodiment will be described. FIG. 18 is a flowchart illustrating a flow of the information processing operation performed by the information processing apparatus C8 in the eighth example embodiment.

The information processing operation performed by the information processing apparatus C8 illustrated in FIG. 18 may be an operation performed when the information acquisition apparatus D8 transmits the biometric information.

As illustrated in FIG. 18, the information processing apparatus C8 receives the biometric information from the information acquisition apparatus D8 (step S90). The verification unit C17 collates/verifies at least one of the biometric information registered in the biometric information database DB and the individual identification information, with at least one of the biometric information received from the information acquisition apparatus D8 and the individual identification information (step S91).

The storage apparatus C2 stores the biometric information received from the information acquisition apparatus D8 in the biometric information database DB as required (step S92). In a case where it is determined from the verification that the biometric information acquired from the same living body is already stored in the biometric information database DB, the storage apparatus C2 may associate the received biometric information with the already stored biometric information, and may store it in the biometric information database DB, as the biometric information acquired from the same living body.

The output control unit C18 determines whether or not additional biometric information is required (step S93). When additional biometric information is required, the output control unit C18 causes the output apparatus C5 to give notice to that effect (step S94). The output control unit C18 also transmits information to that effect to the information acquisition apparatus D8 (step S95). The information transmitted in the step S95 may be the information received in the step S80 illustrated in FIG. 16.

### [8-4: Technical Effect of Information Processing System SYS8]

In the information processing system SYS8 in the eighth example embodiment, the information acquisition apparatus D8 causes the notification element 8 to give notice of the acquisition status of the biometric information, and it is thus possible to prevent erroneous collection of the biometric information. In addition, in a case where the attachment A for which the acquisition of the biometric information is not required is connected to the information acquisition apparatus D8, it is certainly possible to call for attention, as both the information acquisition apparatus D8 and the information processing apparatus C8 output alerts. Furthermore, in a case where there is the biometric information that needs to be, but not yet acquired, for a living body corresponding to the biometric information received from the information acquisition apparatus D8, it is certainly possible to acquire the necessary biometric information, as both the information acquisition apparatus D8 and the information processing apparatus C8 output alerts.

### 9: Ninth Example Embodiment

Next, an information acquisition apparatus, an information acquisition system, an information processing system, an information acquisition method, and a recording medium according to a ninth example embodiment will be described. The following describes the information acquisition apparatus, the information acquisition system, the information processing system, the information acquisition method, and the recording medium according to the ninth example embodiment, by using an information processing system SYS9 to which the information acquisition apparatus, the information acquisition system, the information processing system, the information acquisition method, and the recording medium according to the ninth example embodiment are applied.

### [9-1: Configuration of Information Processing System SYS9]

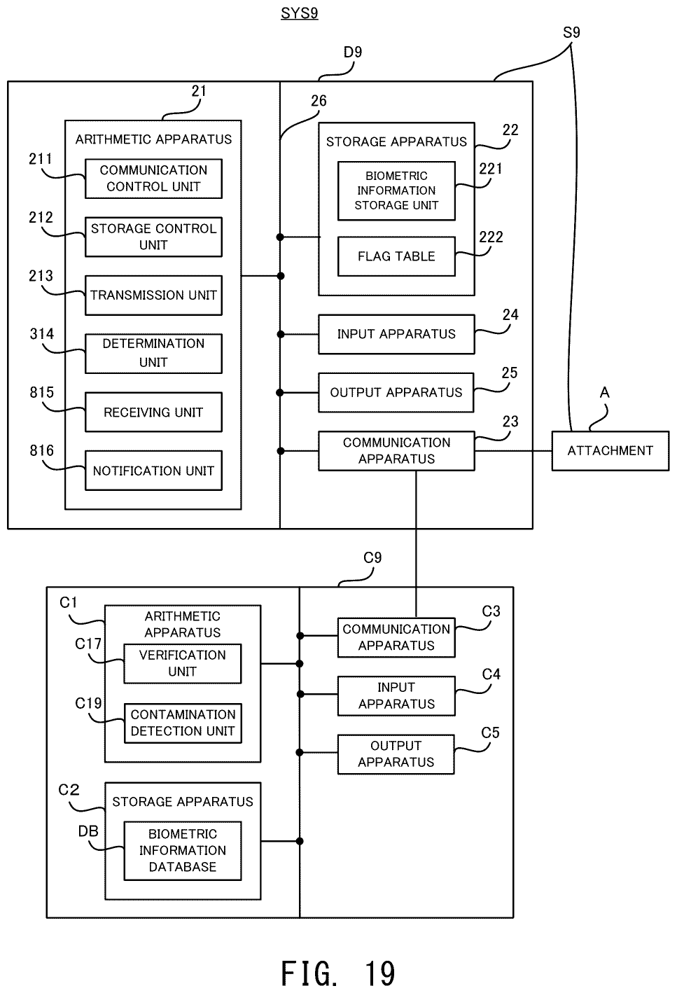

As illustrated in FIG. 19, an information processing apparatus C9) in the ninth example embodiment may include the arithmetic apparatus C1, the storage apparatus C2, the communication apparatus C3, the input apparatus C4, and the output apparatus C5, as in the information processing apparatus C7 ion the seventh example embodiment and the information processing apparatus C8 in the eighth example embodiment. The information processing apparatus C9 in the ninth example embodiment differs from the information processing apparatus C7 in the seventh example embodiment and the information processing apparatus C8 in the eighth example embodiment, in that the arithmetic apparatus C1 further includes a contamination detection unit C19. The contamination detection unit C19 detects contamination of the light receiving unit R. Other features of the information processing apparatus C9 may be the same as those of the information processing apparatus C7 in the seventh example embodiment or the information processing apparatus C8 in the eighth example embodiment. For this reason, a part differing from each of the example embodiments described above will be described in detail below; and a description of the other overlapping parts will be omitted as appropriate.

Furthermore, as illustrated in FIG. 19, the features of an information acquisition system S9 in the ninth example embodiment may be the same as those of an information acquisition system S8 in the eighth example embodiment.

As in the attachment A in the second example embodiment illustrated in FIG. 2A to FIG. 2E, the attachment A in the ninth example embodiment includes the light receiving unit R. As illustrated in FIG. 2A to FIG. 2E, the light receiving unit R1 is a member included in the sensor unit Sen1 provided in the attachment A1. The light receiving unit R2 is a member included in the sensor unit Sen2 provided in the attachment A2 includes. The light receiving unit R3 is a member included in the sensor unit Sen3 provided in the attachment A3. The light receiving unit R4 is a member included in the sensor unit Sen4 provided in the attachment A4.

The contamination detection unit C19 detects contamination of the light receiving unit R. When the attachment A is connected, the attachment A may automatically acquire a contamination detection image obtained by imaging a reference object, and may transmit the image to the information processing apparatus C9 via the connecting unit 11. The reference object may be a monochrome flat object. The storage apparatus C2 may store a reference image obtained by imaging the reference object when the light receiving unit R is not contaminated at all. The contamination detection unit C19 may compare the acquired contamination detection image with the reference image, and may detect a degree of contamination of the light receiving unit R, based on a difference between the images.

The contamination detection unit C19 controls notice of the detected contamination. The information processing apparatus C9 may cause the output apparatus C5 to output guidance corresponding to the degree of contamination. The contamination detection unit C19 may encourage, for example, at least one of replacement, cleaning, and disinfection of the attachment A, depending on the degree of contamination of the light receiving unit R. The contamination detection unit C19, for example, may cause the output apparatus C5 to output guidance encouraging the replacement of the sensor unit Sen, when the degree of contamination is high.

### [9-2: Technical Effect of Information Processing System SYS9]

Since the information processing system SYS9 in the ninth example embodiment is configured to detect the contamination, it is possible to acquire good-quality and useful biometric information.

### 10: Supplementary Notes

With respect to the example embodiment described above, the following Supplementary Notes are further disclosed.

### [Supplementary Note 1]

An information acquisition apparatus including:
a connecting unit to be connected to an information acquisition unit that acquires biometric information;
a storage unit that stores therein the biometric information acquired by the information acquisition unit; and
a transmission unit that transmits the biometric information stored in the storage unit, to another apparatus.

### [Supplementary Note 2]

The information acquisition apparatus according to Supplementary Note 1, further including:
a housing that is carriable with one hand; and
a receiving unit
   that is provided in the housing, and
   that receives an input of an operation instruction to the information acquisition unit.

### [Supplementary Note 3]

The information acquisition apparatus according to Supplementary Note 1 or 2, further including a determination unit that acquires identification information for identifying the information acquisition unit and that determines which information acquisition unit is connected, the identification information being presented by the information acquisition unit, wherein
the storage unit associates and stores therein the biometric information and the identification information indicating a type of biometric information that is acquirable by the information acquisition unit determined by the determination unit.

### [Supplementary Note 4]

The information acquisition apparatus according to any one of Supplementary Notes 1 to 3, wherein
the connecting unit
   includes a plurality of concave parts, and
   is connected to one of multiple types of the information acquisition unit,
a connecting part provided in the information acquisition unit to be connected to the connecting unit
   includes at least one convex part unique to the information acquisition unit,
the information acquisition apparatus further includes a determination unit that determines which of the information acquisition units is connected, depending on which of the plurality of concave parts is connected to the convex part, and
the storage unit associates and stores therein the biometric information and identification information indicating a type of biometric information that is acquirable by the information acquisition unit determined by the determination unit.

### [Supplementary Note 5]

The information acquisition apparatus according to any one of Supplementary Notes 1 to 4, wherein
multiple types of the information acquisition unit are mounted on a mounting part, a relative positional relation of which with the connecting unit is changeable, and
a connecting part of one of the information acquisition units and the connecting unit are connected by changing the relative positional relation between the mounting part and the connecting unit.

### [Supplementary Note 6]

The information acquisition apparatus according to any one of Supplementary Notes 1 to 5, wherein
the storage unit includes a driver corresponding to the information acquisition unit, and
the connecting unit operates the information acquisition unit by using the driver corresponding to the information acquisition unit.

### [Supplementary Note 7]

The information acquisition apparatus according to any one of Supplementary Notes 1 to 6, further including a notification unit including notification elements respectively corresponding to multiple types of the information acquisition unit,
the notification unit causing each of the notification elements to give notice such that
   a first notification manner of a notification element corresponding to an information acquisition unit for which acquisition of the biometric information is not required,
   a second notification manner of a notification element corresponding to an information acquisition unit for which necessary biometric information is not acquired, and
   a third notification manner of a notification element corresponding to an information acquisition unit for which the biometric information is already acquired
   are differ from each other.

### [Supplementary Note 8]

An information acquisition system including:
an information acquisition apparatus including:
   a connecting unit to be connected to an information acquisition unit that acquires biometric information;
   a storage unit that stores therein the biometric information acquired by the information acquisition unit; and
   a transmission unit that transmits the biometric information stored in the storage unit, to another apparatus, wherein
the information acquisition unit includes a housing or a cover member formed of a material including at least one of an ultraviolet resistant material and a boiling resistant material.

### [Supplementary Note 9]

An information processing system including:
an information acquisition apparatus including:
   a connecting unit to be connected to an information acquisition unit that acquires biometric information and another apparatus that processes the biometric information;
   a storage unit that stores therein the biometric information acquired by the information acquisition unit; and
   a transmission unit that transmits the biometric information stored in the storage unit, to the other apparatus, wherein
in response to the transmission unit transmitting the biometric information stored in the storage unit to the other apparatus,
   the other apparatus stores each of the received biometric information, with a same living body identification number added thereto, and
   the storage unit deletes the stored biometric information.

### [Supplementary Note 10]

The information processing system according to Supplementary Note 9, wherein
the information acquisition unit includes a light receiving unit, and
the other apparatus further includes a contamination detection unit that detects and gives notice of contamination of the light receiving unit.

### [Supplementary Note 11]

The information processing system according to Supplementary Note 9 or 10, wherein the other apparatus further includes an output unit that, in response to the information acquisition unit for which acquisition of the biometric information is not required being connected to the information acquisition apparatus, outputs information to that effect.

### [Supplementary Note 12]

The information processing system according to any one of Supplementary Notes 9 to 11, wherein the other apparatus further includes an output unit that, in response to there being the biometric information that needs to be, but not yet acquired, for a living body corresponding to the biometric information received from the information acquisition apparatus, outputs information to that effect.

### [Supplementary Note 13]

An information acquisition method including:
connecting to an information acquisition unit that acquires biometric information;
storing, in a storage unit, the biometric information acquired by the information acquisition unit; and
transmitting the biometric information stored in the storage unit, to another apparatus.

### [Supplementary Note 14]

A recording medium on which a computer program that allows a computer to execute an information acquisition method is recorded, the information acquisition method including:
connecting to an information acquisition unit that acquires biometric information;
storing, in a storage unit, the biometric information acquired by the information
acquisition unit; and transmitting the biometric information stored in the storage unit, to another apparatus.

At least a part of the constituent components of each of the example embodiments described above can be combined with at least another part of the constituent components of each of the example embodiments described above, as appropriate. A part of the constituent components of each of the example embodiments described above may not be used. Furthermore, to the extent permitted by law, the disclosures of all documents (e.g., publications) cited in this disclosure above are incorporated into a part of the description of this disclosure.

This disclosure is not limited to the examples described above. This disclosure is allowed to be changed, if desired, without departing from the essence or spirit of this disclosure which can be read from the claims and the entire identification. An information acquisition apparatus, an information acquisition system, an information processing system, an information acquisition method, and a recording medium with such changes are also intended to be within the technical scope of this disclosure.

### DESCRIPTION OF REFERENCE CODES

SYS7, SYS8, SYS9 Information processing system
S2, S3, S4, S5, S6, S7, S8, S9 Information acquisition system
D1, D2, D3, D4, D5, D6, D7, D8, D9 Information acquisition apparatus
11 Connecting unit
12 Storage unit
13, 213 Transmission unit
211 Communication control unit
212 Storage control unit
221 Biometric information storage unit
H Holding part
CB Collection button
SB Send button
314 Determination unit
11P Concave part
D Driver
815 Receiving unit
816 Notification unit
8E Notification element
8El Light emitting unit
8Ei Illustration part
A Attachment
E Exterior part
AC Connecting unit
ACP Convex part
AG Guide member
R Light receiving unit
M Mounting part
C, C7, C8 C9 Information processing apparatus
C17 Verification unit
C18 Output control unit
C19 Contamination detection unit
DB Biometric information database

What is claimed is:

1. An information acquisition apparatus comprising:
a connecting unit to be connected to an information acquisition unit that acquires biometric information;
at least one memory that is configured to store instructions and the biometric information acquired by the information acquisition unit therein; and
at least one first processor that is configured to execute the instructions to transmit the biometric information stored in the memory, to another apparatus.

2. The information acquisition apparatus according to claim 1, further comprising:
a housing that is carriable with one hand; and
a receiving unit
that is provided in the housing, and
that receives an input of an operation instruction to the information acquisition unit.

3. The information acquisition apparatus according to claim 1, wherein
the at least one first processor is configured to execute the instructions to:
acquire identification information for identifying the information acquisition unit; and
determine which information acquisition unit is connected, wherein the identification information being presented by the information acquisition unit, and
the memory that is configured to associate and store therein the biometric information and the identification information indicating a type of biometric information that is acquirable by the information acquisition unit determined.

4. The information acquisition apparatus according to claim 1, wherein
the connecting unit
includes a plurality of concave parts, and
is connected to one of multiple types of the information acquisition unit,
a connecting part provided in the information acquisition unit to be connected to the connecting unit
includes at least one convex part unique to the information acquisition unit,
the at least one first processor is configured to execute the instructions to determine which of the information acquisition units is connected, depending on which of the plurality of concave parts is connected to the convex part, and
the memory that is configured to associate and store therein the biometric information and identification information indicating a type of biometric information that is acquirable by the information acquisition unit determined.

5. The information acquisition apparatus according to claim 1, wherein
multiple types of the information acquisition unit are mounted on a mounting part, a relative positional relation of which with the connecting unit is changeable, and
a connecting part of one of the information acquisition units and the connecting unit are connected by changing the relative positional relation between the mounting part and the connecting unit.

6. The information acquisition apparatus according to claim 1, wherein
the memory includes a driver corresponding to the information acquisition unit, and
the at least one first processor is configured to execute the instructions to operate the information acquisition unit by using the driver corresponding to the information acquisition unit.

7. The information acquisition apparatus according to claim 1, further comprising a notification unit including notification elements respectively corresponding to multiple types of the information acquisition unit,
wherein the at least one first processor is configured to execute the instructions to cause each of the notification elements to give notice such that
a first notification manner of a notification element corresponding to an information acquisition unit for which acquisition of the biometric information is not required,
a second notification manner of a notification element corresponding to an information acquisition unit for which necessary biometric information is not acquired, and
a third notification manner of a notification element corresponding to an information acquisition unit for which the biometric information is already acquired
are differ from each other.

8. An information acquisition system comprising:
an information acquisition apparatus including:
a connecting unit to be connected to an information acquisition unit that acquires biometric information;
at least one memory that is configured to store instructions and the biometric information acquired by the information acquisition unit therein; and
at least one first processor that is configured to execute the instructions to transmit the biometric information stored in the memory, to another apparatus, wherein
the information acquisition unit includes a housing or a cover member formed of a material including at least one of an ultraviolet resistant material and a boiling resistant material.

9. An information processing system comprising:
an information acquisition apparatus including:
a connecting unit to be connected to an information acquisition unit that acquires biometric information and another apparatus that processes the biometric information;
at least one memory that is configured to store instructions and the biometric information acquired by the information acquisition unit therein; and
at least one first processor that is configured to execute the instructions to transmit the biometric information stored in the memory storage unit, to the other apparatus, wherein
in response to transmitting the biometric information stored in the memory to the other apparatus,
the other apparatus stores each of the received biometric information, with a same living body identification number added thereto, and
the memory that is configured to delete the stored biometric information.

10. The information processing system according to claim 9, wherein
the information acquisition unit includes a light receiving unit, and
the other apparatus includes at least one second processor that is configured to execute the instructions to:
detect contamination of the light receiving unit; and
give notice of the contamination of the light receiving unit.

11. The information processing system according to claim 9, wherein the at least one second processor is configured to execute the instructions to output, in response to the information acquisition unit for which acquisition of the biometric information is not required being connected to the information acquisition apparatus, information about that.

12. The information processing system according to claim 9, wherein the at least one second processor is configured to execute the instructions to output, in response to there being the biometric information that needs to be, but not yet acquired, for a living body corresponding to the biometric information received from the information acquisition apparatus, information about that.

13.-14. (canceled)
